(19) United States
(12) Patent Application Publication
(10) Pub. No.: US 2002/0171674 A1
(43) Pub. Date: Nov. 21, 2002

(54) Kitchen internet appliance

(76) Inventor: Harry G. Paris, Knoxville, TN (US)

Correspondence Address: Lance D. Reich, Esq., BOCKHOP & REICH, LLP, Bldg. 400, Suite 300, 3235 Satellite Blvd., Duluth, GA, 30096, US

(21) Appl. No.: 09/855,857

(22) Filed: May 15, 2001

(51) Int. Cl. G06F 7/00

(52) U.S. Cl. 345/700

(57) ABSTRACT

A system and method for providing food-related information, including recipes, methods, hints and cooking instructions to a user via an interactive computer at a food-related location, such as a kitchen. The interactive computer includes a graphic-user interface (GUI) and one or more speakers, and the GUI is preferably a touch-screen capable of displaying interactive multimedia applications to the user, such as video cooking-step illustrations. The interactive computer alternately further includes a secondary storage device that provides food-related information to the user from a secondary storage media such as a CD-ROM or floppy disk.

### BACKGROUND OF THE INVENTION

1. Field of the Invention

The present invention generally relates to computers and communication networks. More particularly, the present invention relates to an internet-dedicated interactive computer that is resident in a food-preparation location, such as a kitchen, and the interactive computer includes a graphic-user interface (GUI) for a user and is in communication with a database containing food-related information, such as recipes, cooking instructions, and food preparation shortcuts, tips and methods such that the interactive computer can selectively retrieve such cooking and food-related information from the database and interactively present it to the user at the food-preparation location.

2. Description of the Related Art

Food-related information, such as recipes and cooking instructions, is normally stored in cookbooks or on cards in recipe files, which are often kept in the food-preparation location, such as a kitchen. When a person desires to cook, he or she looks at various recipes in the cookbook and determines what recipe is most desirable, or appropriate given the person's mood, the ingredients on hand, and possibly special holiday or dietary requirements. Cookbooks and recipe cards and files, however, have several disadvantages.

Cookbooks and recipe cards and files are sometimes poorly or inappropriately organized and indexed, and regardless of their organization, can be intimidating to both the amateur and expert cook. Furthermore, they can only contain a limited amount of information so they are thus usually limited to a single cuisine, level of cooking skill, or type of meal. Problems can then arise because when a person desires to cook a single meal having a number of dishes from a variety of cuisines, a variety of cookbooks and recipe cards and files must be used. Additionally, cookbooks, recipe cards, and files are bulky and can interfere with the cooking workspace, and can even become soiled with food. In regard to order, cookbooks and recipe cards are inconsistently organized and presented from one publisher to another, creating inefficient, and sometimes confusing, cooking efforts.

There are computer programs that contain recipes and cooking instructions, and these programs can be quite voluminous given the data storage capabilities of most computers. However, cookbook computer programs are difficult to use while cooking as few people keep computers in the kitchen. Furthermore, the computer interactivity can be difficult as the common input devices are a keyboard, and a mouse or touch-pad, and a person who is distracted with food-preparation steps of cooking can have difficulty interacting with the cooking computer program. Thus, to avoid soiling the computer with powders, liquids and other food ingredients, it is usually necessary to print out all recipes to be used and cooking instructions for a particular meal prior to beginning the preparation of the meal.

Additionally, there are dedicated, and sometimes portable, “recipe” devices for use in the kitchen which store recipes and allow the user to selectively choose, fraction or multiply for number of required servings, and prepare the meal according to the resultant printed recipes. Such recipe devices utilize a partial or full ASCII keyboard and dedicated physical buttons, such as START, COMPLETE, and STOP, and they may include one or more timers. Operation of such a defined device is limited, as additional functionality could have been applied in the space where the dedicated keyboard and/or pushbuttons are. Finally, such recipe devices are limited physically in terms of data storage, and presentation, which is usually static text-only display on a limited visibility monochrome LCD display and/or printout. As such, the user easily becomes disenchanted by the sheer monotony of the cooking experience, and is not motivated by the technology to further his or her culinary skills substantially.

Of course, there are recipe files available over the Internet that also have limitations which limit their usefulness. Typically, the user accesses the recipe(s) via the Internet web site(s), downloads the recipe(s), and then prints the recipe(s). Hence, similar limitations to the recipe books and recipe cards listed above apply, including the threat of soiling the recipe(s) during cooking, and requiring another download, thus losing time and possibly ruining the food already in the cooking process. Furthermore, any currently accessible video and/or multimedia files detailing food preparation techniques require playback on a capable computer, and again, the computer is not typically located in the kitchen, nor is it designed for kitchen hazards. Thus, review of multimedia files is frequently viewed on a home computer, away from the food preparation area, and thus, the educational experience is not completely effective.

Furthermore, cooks often desire to know what recipes they can prepare with the specific ingredients that they possess. To learn what recipes are possible, cooks have previously undertaken a tedious manual review of the recipes of one or more cookbooks and after reviewing the ingredients necessary for making a specific recipe, the cook compares the required ingredients with the ingredients available to the cook to see if preparation of the recipe is possible. There are computer programs known which allow a user to input one or more ingredients and the computer will compare the ingredient with a recipe database and generate to the user a list of recipes possible with the specific ingredients. The operator interface, data storage, and presentation is again the limiting element of these devices for reasons similar to the “recipe” devices mentioned previously herein.

These computer programs use secondary storage media, such as a series of floppy disks or CD-ROMs, which are limited in data capacity. Consequently, the secondary storage media is often segregated in the same manner as cookbooks—among types of cuisine, meal categories, food, and/or dietary considerations. Thus, the user must repeatedly change disks to cover a plethora of choices. Moreover, a personal computer is most often not in the kitchen or in proximity thereto, and it is difficult for a cook to verify that all of the necessary ingredients of any particular recipe are on hand without either repeatedly visiting the computer, writing down the ingredients, or having one person use the computer while another communicates what ingredients are present.

Moreover, many people cannot “purge” their cupboards of ingredients for years, as they do not know what drinks, meals, soups, appetizers, deserts, etc. can be made with the ingredient. As a result, in most kitchens, pantries and food preparation areas, there is inevitably a collection of otherwise useful ingredients that end up being wasted due to spoilage, ignorance, or storage issues.

Accordingly, there is a need for a simple to use, dynamic device which is easily and conveniently placed within a kitchen so as to not interfere with the food-preparation process, and which can provide instant access to a practically unlimited amount of food-preparation information. Information available using such a device could vastly exceed the information which can be contained in physical cookbooks and recipe files. To have access to such a wide range of food-preparation information, the device should have access to a database across a network, such as the Internet. Further, the device should have a simple interface whereby a user can simply request and review food-related information with minimal interruption of the food-preparation process. In addition, instant cooking and food preparation methods and tips could be provided to a user in an educational and entertaining manner through the use of interactive and/or multimedia technologies already available anytime throughout the food planning, preparation, cooking and serving process. A person of any cooking skill level would have practically unlimited abilities to prepare any level of meals, drinks, appetizers, soups, deserts, and the like. It is thus to the provision of such a kitchen Internet appliance that can readily provide food-related information to a person in the kitchen that the present invention is primarily directed.

### SUMMARY OF THE INVENTION

The present invention is a dedicated Internet appliance that is placed in a food preparation location, such as a kitchen, and the appliance is in continuous or on-demand communication with a database of food-related information. The kitchen Internet appliance includes an interactive computer at the food-preparation location, and the interactive computer has a graphic-user interface (GUI) and one or more speakers. The interactive computer has a console containing the GUI, and a central processing unit (CPU) with a CPU platform. The CPU of the console interacts with the GUI and selectively communicates with the Internet to request and receive food-related information from the remote database of food-related information.

The GUI of the interactive computer is capable of displaying interactive multimedia applications, such as narrated cooking instructions which can include animation. The interactive computer is in selective communication with the Internet, which can be a direct land-line or wireless transmission, and bridges a selective communication with a remote database of food-related information to make that information accessible to the user of the computer in the kitchen.

For ease of use, the interactive computer preferably includes a touch-screen interface on the GUI so that a user can simply execute commands directly via displayed information, such as icons, simulated push buttons, timers, and the like. The use of the touch-screen minimizes the space required for the interactive computer because other input devices such as keyboards and a mouse are not required. Furthermore, the touch-screen is easily cleaned if food or other cooking related products are spilled or smeared thereupon. Additionally, the touch-screen concept allows practically unlimited screen space for presentation of information, virtual “buttons”, and the like, as well as operator interaction, because only the currently available options are displayed. The button screens can cascade in that as soon as the operator touches the “button,” a new screen can come up with an entirely different array of buttons, information, and the like.

The interactive computer further preferably includes a secondary storage device for receiving food-related information from a secondary storage media, such as a CD-ROM player for receiving CD-ROMs containing cooking instructions and recipes. The food-related information from the secondary storage media is intended to supplement the information available from the database across the Internet. The secondary storage can also work interactively with the database to optimize certain actions of the computer, such as playing multimedia files or other large size files from the faster secondary storage media, as opposed to waiting for transmission of the information across the Internet.

The database of food-related information has access to the Internet, either directly or through a server. The database server preferably includes a comparison engine to compare an inputted list of one or more ingredients from the user at the interactive computer to one or more recipes stored on the database, and also includes multimedia cooking instructions. The instructions are selectively fetched by the interactive computer and displayed at the interactive computer GUI. However, the comparison engine does not need to be resident on the database server, but can be resident on the interactive computer itself or a separate computer platform on the network, provided that the separate computer platform has access to the food-related information on the database for searching recipes.

The interactive computer can further include food-preparation assistance tools which are selectively displayable to the user. The food-preparation tools can include a monitor for the addition of ingredients using an interactive electronic scale, a timer, and conversion tables. The food-preparation tools can be activated by an icon on the GUI, or can be automatically displayed when a specific food-preparation instruction or recipe is executed. The food-preparation tool can terminate after a predetermined time, or can terminate at the conclusion of the instruction step in the food-preparation instruction.

The invention further provides an inventive method for providing food-related information across a network to a user of an interactive computer at a food-preparation location. The method includes the steps of providing a graphic user interface (GUI) on the interactive computer to a user at the food-preparation location, selectively requesting, at the GUI of the interactive computer, food-related information from a database of food-related information in communication with the network, transmitting food-related information from the database to the interactive computer across the network; and displaying the food-related information on the GUI of the interactive computer to the user.

When the system includes a comparison engine to search the database of food-related information, the step of selectively requesting, at the GUI of the interactive computer, is inputting a list of ingredients which the user has available and using the comparison engine at the database to compare the inputted list of one or more ingredients to one or more recipes stored on the database. Subsequently, the step of transmitting food-related information from the database to the interactive computer across the network is transmitting from the database to the user a list of recipes that are possible for the inputted list of ingredients.

If the user requests an illustrative food preparation instruction, the step of selectively requesting, at the GUI of the interactive computer, the food-related information from the database is selectively requesting one or more food-preparation instructions. Then the step of transmitting food-related information from the database to the interactive computer across the network is transmitting multimedia food-preparation instructions to the user from a store of multimedia food-preparation instructions on the database.

In the preferred embodiment, the step of providing a graphic user interface (GUI) on the interactive computer to a user at the food-preparation location is providing an interactive computer including a touch-screen interface on the GUI at the food-preparation location. Furthermore, the preferred embodiment also preferred includes the step of retrieving food-preparation information from a secondary storage media with a secondary storage device of the interactive computer.

The present invention thus provides a kitchen Internet appliance that is easily used by a food preparer in the kitchen, and the device can access vast amounts of food-related information from one or more databases on the Internet. The computing power and data storage available to the interactive touch-screen based computer allows data retrieval and user efficiency beyond what a conventional stand-alone computer can provide with solely primary and secondary data storage. Moreover, because the database is maintained separately from the interactive computer, food-related information can easily be added to, or the database upgraded, without the need to update or provide any materials to the user for modification of the interactive computer.

Furthermore, the interactive computer displays multimedia files on the GUI which represents an instructional advantage to quickly and concisely relay information to the user in the kitchen. A food-preparing user can view an animation of a cooking step on the GUI while hearing verbal explanations and instructions from the speaker(s) of the interactive computer. When embodied with a touch-screen interface, the user can intuitively interact with the command menus and instructions of the system without needing to use other computer input devices such as keyboards or a mouse.

Other objects, features, and advantages of the present invention will become apparent after review of the hereinafter set forth Brief Description of the Drawings, Detailed Description of the Invention, and the claims.

### BRIEF DESCRIPTION OF THE DRAWINGS

FIG. 1 is a pictorial view of the system illustrating the interactive computer, the Internet, database, and database server.

FIG. 2 is a perspective view of the interactive computer embodied on a stand with a landline data connection, speakers, touch-screen display and a secondary storage device.

FIG. 3 is a block diagram of the CPU platform of the interactive computer.

FIG. 4A is a simplified screen image on the GUI of the interactive computer illustrating a recipe with a touch-activated screen, and certain parts of the recipe are selectively activated by the user to display a multimedia illustration, here illustrated as a step of “mixing.”

FIG. 4B is a screen image on the GUI of FIG. 4A, with a multimedia illustration of the step: “mix.”

FIG. 5A is screen image on the GUI of the interactive computer illustrating an ingredient list input screen with a “qwerty” keyboard created on the screen to allow a user to input a list of ingredients that the user has available, and here “hamburger” is being input.

FIG. 5B is a screen image of the GUI of FIG. 5A, and the possible recipes for the inputted ingredient of “hamburger” is illustrated with simple 1-touch recall of the recipe and cooking instructions.

FIG. 6 is a flowchart illustrating the process of the comparison engine in receiving the inputted list of ingredients and generating a list of recipes possible with the given ingredients, as is shown in FIGS. 5A and 5B.

### DETAILED DESCRIPTION OF THE INVENTION

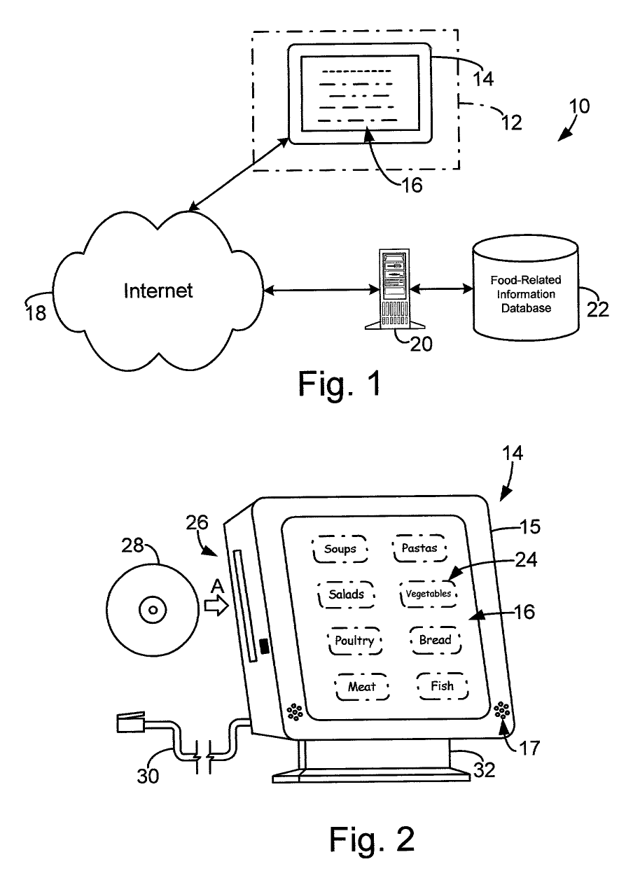

With reference to the figures in which like numerals represent like elements throughout, FIG. 1 illustrates a system 10 for providing food-related information to an interactive computer 14 at a food-related location 12. The interactive computer 14 has a graphic-user interface (GUI) 16 and one or more speakers 17 (FIG. 2) so that it can execute and display multimedia files to a food preparer at the food-preparation location 12. The interactive computer 14 is in communication with a network or host computer, and preferably the Internet 18, whereby the interactive computer 14 can selectively access a database 22 comprised of at least food-related information, such as recipes, cooking instructions, and a comparison engine for determining what recipes can be made from a list of ingredients input by the food-preparer. As is common in network applications, the database 22 is in communication with a database server 20 to control communication between the Internet 18 and database 22.

As shown in FIG. 2, the interactive computer 14 further including a console 15 having a touch-screen graphic user interface (GUI) 16 capable of presenting, displaying, and otherwise communicating interactive multimedia applications, such as animated cooking instructions. The console 15 further includes one or more speakers 17 to audibly broadcast information to the user. The console 15 and GUI 16 can be any flat or curved touch-screen as is known in the art. Furthermore, while the input device for the user here is a touch-screen, other input devices can alternately be used, such as a keyboard, mouse, track ball, separate touch pad, or voice-command system, or a combination thereof with a simple GUI comprised of a cathode ray tube (CRT), LED or LCD display, for example. The interactive computer is attached to the Internet 18 or other network via a data line 30, which can be a phone line out to the phone network and which dials into a Internet host. Alternately, the data line 30 a can be a common network connection such as CAT 5 twisted pair cable with an RJ-45 connector, DSL, Cable modem, or a wireless connection to the internet through a cellular relay or an aerial connection to a voice/data feed such as a 900 Mhz phone base or though other wireless LANs.

The GUI 16 is shown here as displaying touch-activated icons 24 where each icon illustrated a meal course or food group that the user can select information about. The user therefore presses the desired icon 24 on the touch-screen GUI 16 to have the interactive computer 14 requests the data for the specific cuisine from the database 22. The use of the touch-activated icons 24 allows the user to easily interact with the command menu of the system 10 without having to become familiar with a complicated user-interface or command structure.

The interactive computer 14 further preferably includes a secondary storage device, shown here as a CD-ROM reader or DVD player 26 that is integrated with the console 15. The CD-ROM receives a CD 28 having food-related information upon it which can be entirely different from the information on the database 22 and the user can solely draw information from the CD 28 without needed to access the database 22. Alternately, the CD 28 or other secondary storage media can provide supplemental programs, multimedia files or other data to the user at the GUI 16.

The console 14 of the interactive computer is shown in FIG. 2 as on a base 32 such that it stands upright on a level surface. However, the console 15 can be affixed to any surface in the kitchen (food-preparation location 12) or can be placed on a base 32 such that it can be moved around the kitchen to where the user desires it. The console 15 can be embodied with either an internal power source, such as batteries, or an external power source, such as power cord (not shown). If the interactive computer 14 is embodied with a data line 30 and power cord, then console 15 is constrained in location as proximity to a data port (or phone jack) and a power socket are required to operate the interactive computer 14 and have full access of the system 10. However, if the console 15 is embodied with a wireless Internet connection and an internal power source, then the console 15 can be placed virtually anywhere in the kitchen, such as on the front or side of appliances, attached or built-in to the appliance, and cabinetry at very high or low locations, because the console 15 does not need to be proximate to a data port or a power socket.

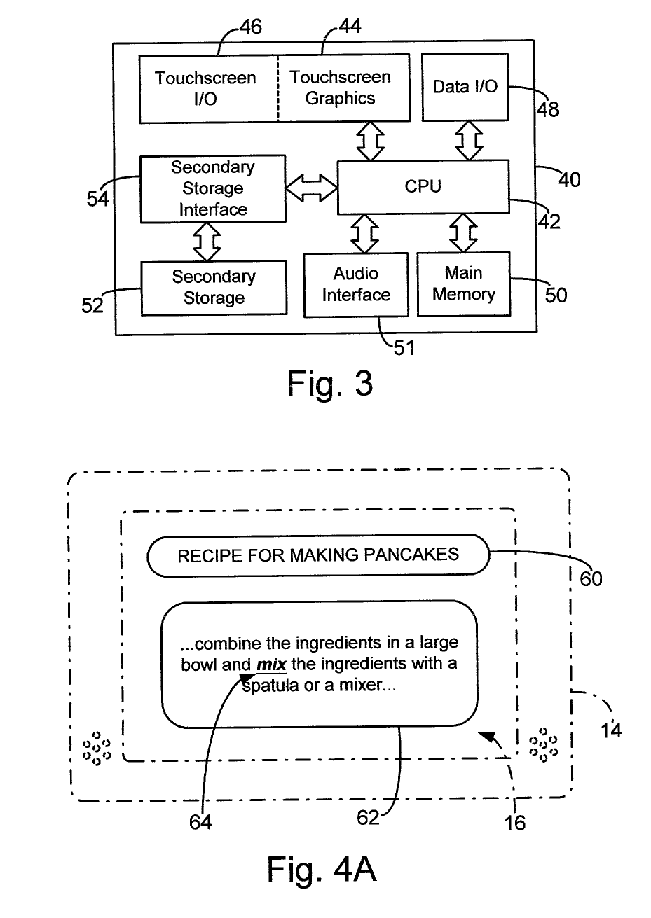

With reference to FIG. 3, there is shown a block diagram of the CPU platform 40 of the interactive computer 14. The main CPU 42 of the interactive computer 14 can be one or more microprocessors as know in the art, such as those made by Motorola, Intel, IBM, or Transmeta, and the CPU platform 40 can be any motherboard or computer control board as known in the art. The CPU 42 is in communication with and controls the GUI, which here is the touch-screen graphics driver 44 and the touch-screen I/O (i.e. the data interface for the touch-screen). The CPU 42 is in further communication with a general data I/O 48 for communication to the network, such as an Ethernet or the Internet. The CPU 42 further preferably has a main memory 50 to store data during operation of the interactive computer 14, although, if sufficient cache is present on the CPU 42 or if the secondary storage 52 is used, it is not necessary to provide a main memory 50.

On the CPU platform 40 is also an audio interface 51 and a secondary storage interface 54. The audio interface 51 allows the CPU 42 to control the one or more speakers and/or audio output port(s) 17 to broadcast the audible portions of the multimedia files of food-related information. The secondary storage interface 54 allows the CPU 42 to communicate with the secondary storage 52 such that data transfer can be accomplished from the secondary storage 52 through the secondary storage interface 54 to the CPU 42. The CPU 42 will then manipulate the data in the appropriate manner, such as displaying the data on the touch-screen GUI 16. All of the devices on the CPU platform 40 are preferably connected through a serial communication bus; however, other methods of interconnecting electronic devices on the same platform can alternately be used in the present invention, such as Universal Serial Bus and other current and future electrical interface standards.

The interactive computer 14 can include other data interfaces and storage devices as are known in the art. Thus, the interactive computer 14 can alternately incorporate parallel, serial, and/or USB interfaces to support peripheral device, such as external cameras, speakers, microphones, external scales, thermometers, other cooking instruments, printers, scanners, other audio-video devices such as VCR, DVD. CD, separate TV or monitor (to include providing a picture-in-picture function), radio, intercoms, or other wireless communication devices.

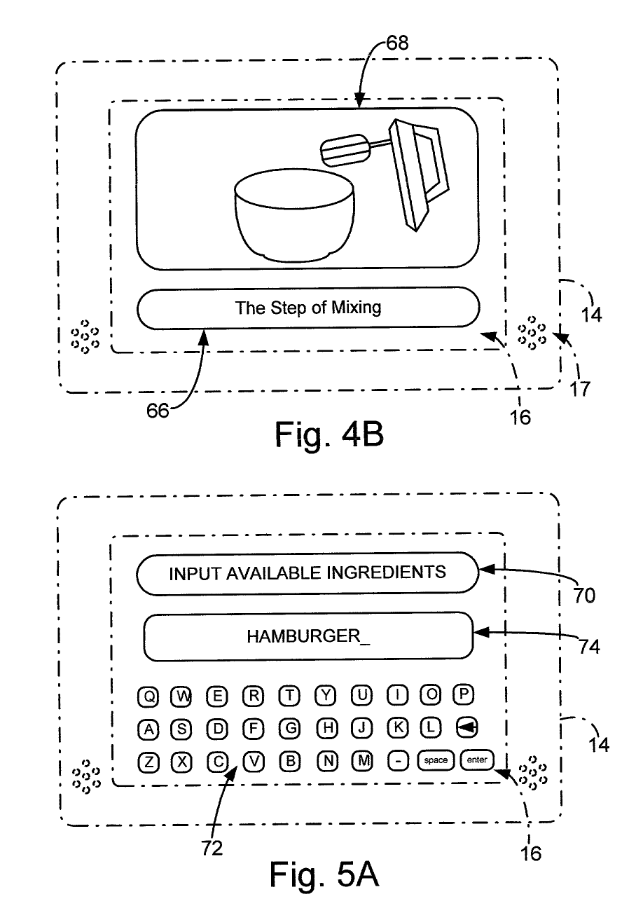

In FIGS. 4A and 4B, there is shown one feature of the interactive computer 14 wherein the GUI 16 (preferably touch-screen) displays an interactive recipe 60 including at least one ingredient and at least one food preparation (e.g. cooking) instruction. The interactive recipe includes one or more hyperlinks, especially in food preparation instructions, that is preferably a multimedia file, such as an MPEG or JPEG, stored at the database 22, which can include entertaining electronic animations and audio files. In FIG. 4A, the recipe 60 is shown as readily identifiable header on the GUI 16 screen. The user pulls-up this screen from a command menu which can be created in any manner known in the art of software engineering. The recipe screen will include a text portion 62 describing the ingredients and actions necessary to make the identified recipe; Here, the interactive recipe is for making pancakes. Within the text of the recipe, there can be highlighted text or icons that allows the user to select a multimedia demonstration of a specific cooking action. In the text portion 62 of the pancake recipe 60, the text word of “mix” 64 is in a highlighted text format to alert the user that he or she can touch the word “mix” 64 to see a multimedia presentation on the step of mixing, as is shown in FIG. 4B.

Once the user has activated the “mix” text word 64 link in FIG. 4A, the CPU 42 accesses the database 22, or the secondary storage 52 if the relevant information is present on the secondary storage media, and requests the information on “mix.” The database server 20 (shown in FIG. 1) receives the request and performs a search on the database 22 for the “mix” information and then sends the information, to expressly include any multimedia files, to the interactive computer 14. Here, the interactive computer 14 has received a multimedia file illustrating the step of mixing, which is shown in the title icon 66 of FIG. 4B. In an animated window 68, the actual step of mixing is shown, and any audible directions are simultaneously broadcasted on the one or more speakers 17. The screen shown in FIG. 4B is merely illustrative of the multimedia file being displayed to the user, and other controls, icons, overlays, or screen items can be included on the screen as desired, such as a virtual control to manipulate the multimedia file with functions such as “stop,” “slow play,” “pause,” “repeat” and more. Furthermore, audible instructions or prompts can be played through the speaker(s) 17 to free the user from being “glued” to the monitor every step of the way.

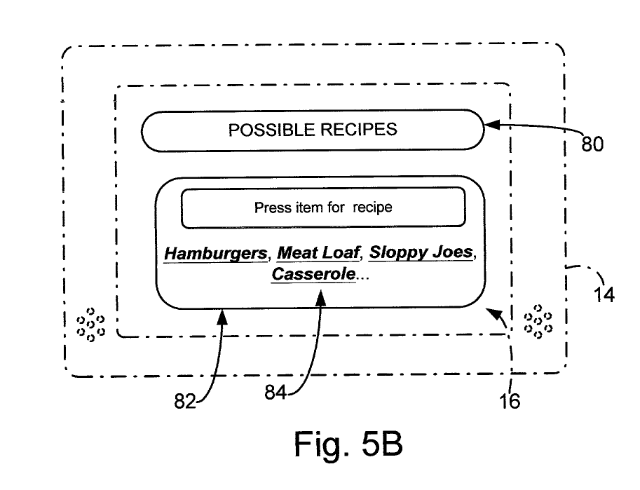

With reference to FIGS. 5A and 5B, there is shown a second feature of the interactive computer 14 wherein a user can input a list of ingredients at the interactive computer 14 and then receive a list of recipes possible for the inputted list of ingredients. In FIG. 5A, the GUI 16 has a title section 70 which requests the user to input a list of ingredients that the user has available. The GUI 16 includes a series of touch-screen keys to emulate a “qwerty” keyboard 72 whereby the user can spell the ingredients and enter them. The typed text is displayed in text section 74 and the entire spelling may not be necessary as “word completion” software which is well known in the art could be implemented. Because this is a software generated keyboard, other keyboard variances could appear instead, including the most basic “alphabetic” and the latest “Dvorak”keyboard designs. Specific user preferences can be easily implemented, such as “alphabetic” keyboard layout for children and those who are hindered by the traditional “Qwerty” keyboard layout, and “enlarged” keys for those who prefer larger buttons, such as a person with health problems such as arthritis, poor hand-eye coordination, and reduced eyesight. Additionally, an alternative graphic selection of ingredients could be implemented for quickest ingredient selection rather than typing them out.

Here, the user has stated that the available ingredient is “hamburger.” Once the ingredient is typed, the user hits enter and the CPU 42 of the interactive computer sends the list to the database server 20 across the Internet 18.

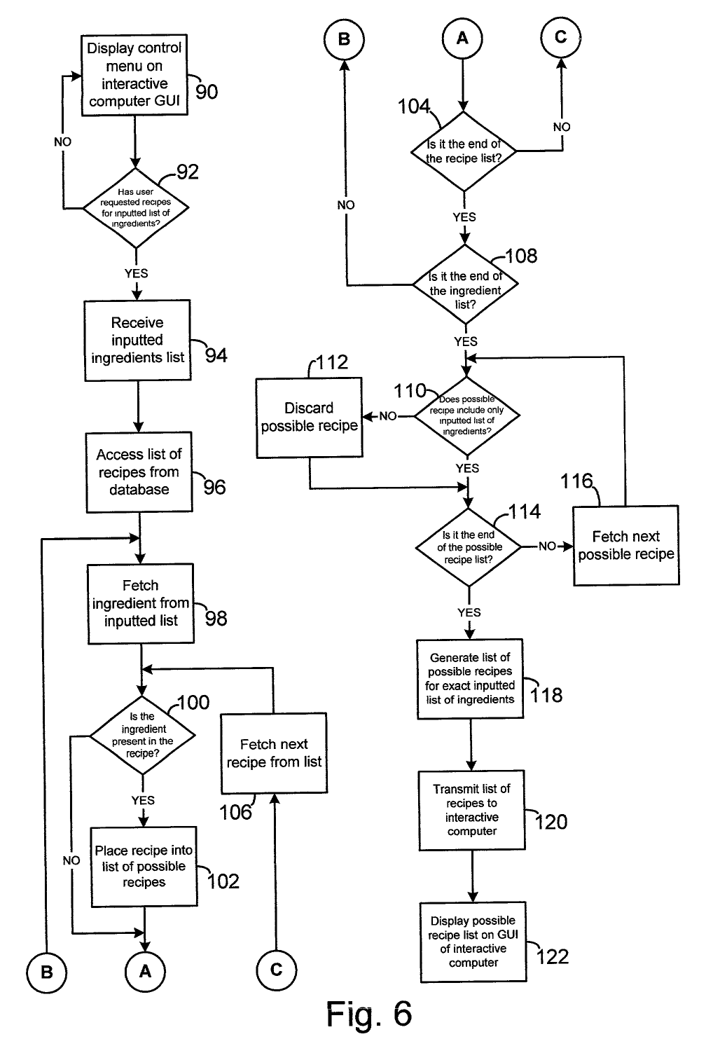

Once the database server 20 receives the inputted list of ingredients from the interactive computer 14, the database server 20 performs the comparison process which is particularly set forth in FIG. 6. The database server 20 locates the applicable recipes in the database 22 that can be made with the inputted ingredients and returns the recipe list to the interactive computer 14. The interactive computer 14 receives the recipe list from the database server 20 and displays the list in the manner shown in FIG. 5B. The GUI 16 identifies in the title section 80 that the screen is displaying the possible recipes, and the actual recipes are displayed in the text section 82. Here, the individual recipes available 84 are links to the actual recipe such that if the user desires to see the recipe, he or she can touch the text word of the individual recipe 84 and the interactive computer 14 will retrieve the recipe from either the database 22 (through database server 20) or the secondary storage 52 if relevant information is contained thereon. As with other files the interactive computer 14 executes, the recipe comparison can be guided with audible instructions projected from the speaker(s) 17 to state the status of the search or recite the list of available ingredients.

FIG. 6 is a flowchart illustrating the recipe list generation process for and inputted list of ingredients. This process can be executed in software on the CPU platform 40, the database server 20, or any other computer platform that is in communication with the interactive computer 14 and the database 22 or database server 20 such that the other computer platform can search the stored food-related information of the database 22. The control menu is displayed on the GUI 16 of the interactive computer 14, as shown at step 90, and then a decision is made as to whether the user has requested recipes for a list of inputted ingredients, as shown at decision 92. In essence, the interactive computer 14 is in a wait state at the input list screen (FIG. 5A), thus if there is no list input at decision 92, the process returns to step 90 once again until a list is input. Of course, other interrupts of the wait state are possible depending upon the specific system and controls available.

Once the user at decision 92 inputs the list, the ingredient list is received at the platform where the process is being executed, as shown at step 94, which here would be the database server 20 (the caller). The caller then access a list of recipes from the database 22, as shown at step 96 and then the caller uses a “comparison engine” to search the recipe list and compare the input ingredients with the recipes to generate a possible recipes list. To begin the comparison process, the first ingredient is fetched from the inputted ingredient list, as shown at step 98, and then a comparison is made with the first recipe in the recipe list, as shown at decision 100, to determine if the ingredient is present in the recipe. If the ingredient is present in the recipe, then the recipe is placed in the list of possible recipes as shown at step 102 and a decision is then made as to whether the end of recipe list is reached as shown at decision 104. If the ingredient is not present in the recipe at decision 100, then the caller goes to decision 104 to determine if the end of the recipe list is reached. If the end of the recipe list is not reached, the caller fetches the next recipe from the list, as step 106, and then a decision is again made as to whether the ingredient is present in the list, or decision 100.

If the end of the recipe list is reached at decision 104, then a decision is made as to whether the end of the ingredient list is reached, shown as decision 108. If the end of the ingredient list is not reached, then the caller returns to step 98 to fetch the next ingredient from the inputted list. If the end of the ingredient list is reached at decision 108, then a decision is made as to whether the possible recipe includes only ingredients which are found within the inputted list of ingredients, as shown at decision 110. If the recipe contains ingredients that are not within the recipe list, then the possible recipe is discarded, as shown at step 112. If the recipe only contains ingredients that are in the possible recipe list, or after the recipe has been discarded at step 112, a decision is then made if the end of the possible recipe list has been made, shown as decision 114. If the end of the possible recipe list has not been reached, then the next possible recipe is fetched, as shown at step 116, and the determination is made if the fetched possible recipe contains ingredients which are in the inputted ingredient list, or decision 110. If the end of the possible recipe list has been reached at decision 114, then the list of possible recipes for the exact inputted list of ingredients is generated, as shown at step 118, transmitted to the interactive computer 14 across the Internet 18, as shown at step 120, and the possible recipe list is displayed on the GUI 16 of the interactive computer 14, as shown at step 122, and is reflected on the GUI 16 in FIG. 5B.

It should be noted that a separate routine, subroutine, or thread can be engaged by the user from touching an icon on the GUI 16, or can be automatically engaged by the system during execution of the main routine. The separate routine can present separate cooking hints, tips, directions, and the like, at any point in execution of the main program. Such routine or subroutine can also monitor the progress of the main cooking instruction and if one or more hints have been requested by the user, the system can provide additional data, video, audio, and the like, at certain intervals in the main instructions, such as when a new cooking step is needed. The system can also provide further icons to the user at the GUI 16 at the various intervals wherein the user is prompted to choose activation of the routine, subroutine, or thread.

In summary of the comparison engine process, the database server 20 (preferably) receives the inputted ingredient list (step 94) and obtains a list of recipes (step 96) and then compares each ingredient with a list of recipes. A possible list of recipes is constructed where specific ingredients are found in a recipe, and then once the end of the inputted ingredient list is reached (decision 108), an exact comparison of the possible recipe list and the inputted ingredient list is made (step 110) to create an exact possible recipe list. This method of generating the list is preferred as it is more efficient to narrow the possible recipes before comparing the entire inputted ingredient list. However, other methods to search the recipes and compare the lists can be alternately used in the present invention to ultimately provide the possible recipes list to the user at the interactive computer 14.

It can be seen that the system 10 further provides an inventive method for providing food-related information across a network, such as the Internet 18, to a user of an interactive computer 14 at a food-preparation location 12. The method includes the steps of providing a graphic user interface (GUI) 16 on the interactive computer 14 to a user at the food-preparation location 12; selectively requesting, at the GUI 16 of the interactive computer 14, the food-related information from a database 22 of food-related information in communication with the network (Internet 16); transmitting food-related information from the database 22 to the interactive computer 14 across the network (internet 16); and displaying the food-related information on the GUI 16 of the interactive computer 14 to the user.

The step of selectively requesting, at the GUI 16 of the interactive computer 14, the food-related information from a database 22 can be inputting a list of ingredients which the user has available, and the method then further includes the step of using a comparison engine at the database (or database server 20 or other CPU as discussed above) to compare the inputted list of one or more ingredients to one or more recipes stored on the database, and is shown in FIGS. 5A and 5B, and the process of FIG. 6. The step of transmitting food-related information from the database 22 to the interactive computer 14 across the network (Internet 18) is transmitting from the database 22 to the user a list of recipes that are possible for the inputted list of ingredients, such as is shown in FIGS. 4A and 4B. Thus, when so embodied, the step of selectively requesting, the food-related information from a database 22 of food-related information in communication with the network (Internet 18) is selectively requesting one or more food-preparation instructions. Then the step of transmitting food-related information from the database 22 to the interactive computer 14 across the network (Internet 18) is transmitting multimedia food-preparation instructions to the user from a store of multimedia food-preparation instructions on the database 22, as is shown in FIG. 4B.

Further, the step of providing a graphic user interface (GUI) 16 on the interactive computer 14 to a user at the food-preparation location 12 is preferably providing an interactive computer 14 including a touch-screen interface on the GUI 16 at the food-preparation location 12. When the interactive computer 14 is embodied with a secondary storage device 52 for receiving food-related information from a secondary storage media, such as CD-ROM 28, then the method includes the step of retrieving food-preparation information from a secondary storage media with a secondary storage device of the interactive computer.

While there has been shown a preferred embodiment of the present invention, it is to be understood that certain changes may be made in the forms and arrangement of the elements and steps of the method without departing from the underlying spirit and scope of the invention as is set forth in the claims.

What is claimed is:

1. A system for providing food-related information to an interactive computer at a food-preparation location, comprising:
an interactive computer at the food-preparation location, the interactive computer including a graphic-user interface (GUI) and one or more speakers, the GUI capable of displaying interactive multimedia applications, and the interactive computer attached to a network; and
a database of food-related information in selective communication with the network,
wherein the interactive computer selectively communicates with the database to provide food-related information to the user at the GUI of the interactive computer.

2. The system of claim 1, wherein the database of food-related information comprises at least:
a comparison engine to compare an inputted list of one or more ingredients to one or more recipes stored on the database; and
a store of multimedia cooking instructions selectively fetched and displayed at the GUI of the interactive computer.

3. The system of claim 1, wherein the interactive computer includes a touch-screen interface on the GUI.

4. The system of claim 1, wherein the interactive computer further includes a secondary storage device for receiving food-related information from a secondary storage media.

5. The system of claim 1, further including one or more food-preparation tools displayable at the GUI of the interactive computer.

6. The system of claim 2, wherein the interactive computer displays multimedia cooking instructions at the food preparation location.

7. A method for providing food-related information across a network to a user of an interactive computer at a food-preparation location, the method comprising the steps of:
providing a graphic user interface (GUI) on the interactive computer to a user at the food-preparation location;
selectively requesting, at the GUI of the interactive computer, food-related information from a database of food-related information in communication with the network;
transmitting food-related information from the database to the interactive computer across the network; and
displaying the food-related information on the GUI of the interactive computer to the user.

8. The method of claim 7, wherein:
the step of selectively requesting, at the GUI of the interactive computer, the food-related information from a database of food-related information in communication with the network is inputting a list of ingredients which the user has available; and
further including the step of using a comparison engine at the database to compare the inputted list of one or more ingredients to one or more recipes stored on the database; and
wherein the step of transmitting food-related information from the database to the interactive computer across the network is transmitting from the database to the user a list of recipes that are possible for the inputted list of ingredients.

9. The method of claim 7, wherein:
the step of selectively requesting, at the GUI of the interactive computer, the food-related information from a database of food-related information in communication with the network is selectively requesting one or more food-preparation instructions; and
the step of transmitting food-related information from the database to the interactive computer across the network is transmitting multimedia food-preparation instructions to the user from a store of multimedia food-preparation instructions on the database.

10. The method of claim 7, further including the step of selectively displaying a food-preparation tool at the GUI of the interactive computer.

11. The method of claim 7, further including the step of retrieving food-preparation information from a secondary storage media with a secondary storage device of the interactive computer.

12. The method of claim 9, wherein:
the step of selectively requesting, at the GUI of the interactive computer, the food-related information from a database of food-related information in communication with the network is selectively requesting at the GUI of the interactive computer food-related information from a database across the Internet; and
the step of transmitting food-related information from the database to the interactive computer across the network is transmitting food-related information across the Internet from the database to the interactive computer.

13. The method of claim 9, wherein the step of displaying the food-related information on the GUI of the interactive computer to the user is displaying multimedia cooking instructions on the GUI of the interactive computer.

14. An interactive computer for the selective retrieval and display of food related information as a food-preparation location, comprising:
a console having a graphic-user interface (GUI), the GUI allowing a user to request food-related information and view such food-related information in multimedia format; and
a central processing unit (CPU) including a CPU platform, the CPU interacting with the GUI and in selective communication with a network, and the CPU selectively retrieving food-related information from one or more databases of food-related information on the network.

15. The interactive computer of claim 14, wherein the GUI includes a touch screen interface.

16. The interactive computer of claim 14, further including a secondary storage device for interfacing with a secondary storage media containing food-related information.

17. The interactive computer of claim 14, wherein the food-related information is food-prep instructions selectively fetched and displayed at the GUI of the interactive computer.

18. The interactive computer of claim 14, wherein the CPU further selectively displays food-preparation tools on the GUI of the console.

19. A method of providing recipe information to a user at a food-preparation location, comprising the steps of:
receiving, from a network, a list of ingredients from the user at a food preparation location, the list of ingredients inputted from an interactive computer at the food preparation location;
comparing the inputted list of ingredients with a plurality of recipes from a recipe database;
generating a list of recipes wherein each recipe contains ingredients which are only present in the list of ingredients inputted by the user; and
transmitting the generated list of recipes to the interactive computer of the user across the network.

20. A method of providing a hyper-linked recipe to a user of an interactive computer in a food-preparation location, comprising the steps of:
presenting on the interactive computer a recipe that includes at least one ingredient and at least one food-preparation instruction, wherein the at least one food preparation instruction includes a hyperlink;
activating the hyperlink of the at least one food preparation instruction; and
presenting on the interactive computer a multimedia file providing information about the at least one food preparation instruction.
